(19) United States
(12) Patent Application Publication
(10) Pub. No.: US 2006/0292266 A1
(43) Pub. Date: Dec. 28, 2006

(54) Functional Water and Method and System for Its Production

(75) Inventor: Masaaki Okuda, Matsubara-shi (JP)

Correspondence Address: John W. Carpenter;Suite 400, 155 Sansome Street, San Francsico, CA, 94104-3614, US

(73) Assignee: SEIWA PRO CO., LTD., Matsubara-shi (JP)

(21) Appl. No.: 11/164,492

(22) Filed: Nov. 25, 2005

(30) Foreign Application Priority Data
Jun. 30, 2004 (JP) 2004-192887

(51) Int. Cl. C12C 5/02

(52) U.S. Cl. 426/66; 426/74

(57) ABSTRACT

Functional water (drinking water) having a dissolved oxygen content of 25 to 70 mg/l immediately after processing to dissolve oxygen in source water, and remaining 15 mg/l or more after the functional water is exposed to air for 24 hours. A purification processor (11) processes the source drinking water, and an additive processor (15) then adds components such as vitamins, minerals, and amino acids. An oxygenation processor (20) then produces the functional water (drinking water) by dissolving oxygen in the source water after having been processed by the additive processor (15). A bottling processor (16) then fills transportable containers with the drinking water and seals the containers.

### BACKGROUND OF THE INVENTION

1. Technical Field

The present invention relates to functional water containing a high concentration of dissolved oxygen, and to a method and system for producing such functional water.

2. Description of the Related Art

Various functional water products, such as bottled functional water beverages, containing a high concentration of dissolved oxygen have become available. In addition to absorption through the lungs, oxygen can be absorbed through the stomach and intestines from functional water beverages having a high dissolved oxygen content and oxygen thus absorbed through the digestive tract has been shown to have various health benefits, including promoting the breakdown of alcohol in alcoholic beverages and preventing hangovers, preventing a drop in oxygen supply to various parts of the body caused by carbon monoxide in tobacco smoke, accelerating metabolism and promoting waste discharge, and reducing fatigue when exercising by promoting the breakdown of lactic acid produced.

Japanese Unexamined Pat. App. Pub. No. 2001-292748 discloses a method of manufacturing bottled functional water from deep seawater. Seawater collected from deep ocean depths is desalinated to a specific chlorine concentration, and oxygen is then dissolved in the desalinated water to increase the dissolved oxygen concentration from 6-8 mg/l to 25-30 mg/l. The oxygenated water is then bottled and sealed. Because it contains various natural minerals found in deep seawater and has a high dissolved oxygen content, this bottled water has high added-value as functional water with various health benefits.

As disclosed in Japanese Unexamined Pat. App. Pub. No. H10-314561, one method of dissolving oxygen in water (drinking water) is to pass air or oxygen gas produced by an oxygen generator through water, thereby dissolving the oxygen in the water.

With conventional bottled water, however, the dissolved oxygen is released into air when the bottle is subsequently opened and the drinking water inside the bottle is exposed to air. The amount of dissolved oxygen in the water thus decreases over time and in a short time drops to the same level as before the oxygenation process.

This has meant that once the bottle is opened, the drinking water in the bottle should either be drunk all at once, or the unconsumed portion just thrown away; that is, because the dissolved oxygen content in the water drops after a certain amount of time has passed, despite drinking the leftover portion, consumers have been unlikely to gain the above-described benefits, and thus have not been able to drink just the amount that they want to drink when they want to drink it.

Thus, a problem with conventional functional water such as the bottled water described above is that even if the amount of dissolved oxygen immediately after the oxygenation process is high, the dissolved oxygen content soon drops to the same level as before the oxygenation process if the oxygenated water is left exposed to air.

### BRIEF SUMMARY OF THE INVENTION

An object of the present invention, taking the foregoing circumstances into consideration, is to make available functional water in which the volume of dissolved oxygen is large immediately after the water has undergone an oxygenation process, and in which the dissolved oxygen is unlikely to drop even when the water is left in the air. A further object is to provide a method and an system for producing such functional water.

In order to achieve the foregoing objective, a first aspect of the present invention is functional water in which oxygen is dissolved in source water to a concentration exceeding the natural dissolved oxygen concentration, the dissolved oxygen content immediately after processing to dissolve the oxygen is 25 mg/l to 70 mg/l, and the dissolved oxygen content of the oxygenated functional water after exposure to air for 24 hours is 15 mg/l or greater.

This functional water preferably also contains at least a vitamin, mineral, amino acid, or pharmaceutical, and is charged into and sealed within a portable container.

Immediately after the oxygenation process dissolving the oxygen in source water, the resulting functional water has a high dissolved oxygen concentration of in the range of 25 mg/l to 70 mg/l, and the dissolved oxygen concentration remains at least 15 mg/l after the functional water is exposed to air for up to 24 hours. When this functional water is used as drinking water, for example, the dissolved oxygen content of the water remains high after the sealed portable container filled the functional water is opened. As a result, the desired amount of this drinking water (functional water) can be consumed when desired, and oxygen sufficient to afford the beneficial effects described above can be absorbed whenever the water is consumed. This functional water is therefore easy to handle and use. Herein, the dissolved oxygen content 24 hours after exposure to air is more desirably 35 mg/l or more.

In addition to its use as drinking water, this functional water can be used to manufacture medicines and cosmetics. If used in eye medicine, eyewash, or a cosmetic lotion, for example, oxygen will be absorbed through the surface of the eye or skin, and this functional water thus has the effect of stimulating the metabolism in those areas. Note that these are merely examples of the many applications and uses of this functional water, and the invention shall not be limited thereto.

The product value of this functional water is also improved because the dissolved oxygen content of functional water according to the present invention does not decrease easily when exposed to air. The value of this functional water can be yet further improved by adding at least a vitamin, mineral, amino acid, or pharmaceutical to the water.

The functional water of this invention can be suitably produced using a production method according to another aspect of the invention as described below.

In accordance with the production method, inside a sealed tank in which oxygen-gas pressure has been elevated to atmospheric pressure or greater, source water is discharged out in film form, causing the water to come into contact with the oxygen gas along either side of the film, raising the content of dissolved oxygen in the source water to 25 to 70 mg/l, from 6 to 8 mg/l prior to being processed, thereby generating functional water of high oxygen concentration, and that even after having been left in the air for 24 hours can maintain a dissolved oxygen content of 15 mg/l or more, more desirably 35 mg/l or more. This is because when hydrogen molecules and oxygen molecules come in contact with each other in a high pressure oxygen atmosphere, some of the molecules are ionized and oxygen is dissolved in the water by ion bonds formed between hydrogen molecules and oxygen molecules. These ion bonds result in water in which the concentration of dissolved oxygen is high and the dissolved oxygen content does not decrease easily. The functional water thus generated is then removed from the sealed tank.

This production method preferably purifies the source water by reverse osmosis, and supplies the purified source water into the sealed tank.

Yet further preferably, this production method adds at least a vitamin, mineral, amino acid, or pharmaceutical to the source water and then supplies the source water into the sealed tank after this addition process.

Alternatively, this production method adds at least a vitamin, mineral, amino acid, or pharmaceutical to purified source water, and then supplies the source water to the sealed tank after the addition process.

Further alternatively, this production method adds at least a vitamin, mineral, amino acid, or pharmaceutical to functional water acquired from in the sealed tank.

Yet further preferably, this functional water production method fills transportable containers with functional water taken from inside the sealed tank and then seals the containers, or fills transportable containers with functional water to which at least a vitamin, mineral, amino acid, or pharmaceutical is added and then seals the containers.

This production method can be suitably implemented with a functional water production system as described below.

This functional water production system has an oxygenation unit for producing functional water by dissolving oxygen in source water to a concentration exceeding the natural dissolved oxygen concentration, and a bottling unit for filling transportable containers with the functional water generated by the oxygenation unit and then sealing the containers.

The oxygenation unit includes: a sealed tank; an oxygen supply means comprising a supply pipe connected to the inside of the sealed tank, supplying oxygen gas through the supply pipe into the sealed tank, and creating an oxygen atmosphere pressurized to greater than atmospheric pressure inside the tank; a water supply means comprising a first water supply pipe of which one end is connected to the inside of the sealed tank and is disposed vertically inside the sealed tank, with a discharge outlet formed in the top end so that the water supply means discharges the source water from the discharge outlet of the first water supply pipe toward the ceiling of the sealed tank; a second water supply pipe connected to the inside of the sealed tank for externally supplying functional water collected in the bottom of the sealed tank; and a first flow control member projecting inward from the inside surface of the sealed tank, and/or a flat second flow control member projecting outward from the outside surface at the one end of the first water supply pipe. This oxygenation unit discharges source water from the discharge outlet towards the ceiling of the sealed tank, and causes source water discharged from the discharge outlet and flowing along the inside wall of the sealed tank and/or the outside surface of the first water supply pipe to flow down through space inside the sealed tank from the projecting edge of the first flow control member and/or second flow control member, thereby causing gas-liquid contact between the source water and oxygen gas inside the sealed tank and producing functional water.

The bottling unit then fills transportable containers with functional water supplied from the second water supply pipe of the oxygenation unit and then seals the transportable containers.

The oxygenation unit of this production system first produces functional water from source water. More specifically, the oxygen supply means supplies oxygen gas through the oxygen supply pipe into the sealed tank to create an oxygen atmosphere pressurized to greater than atmospheric pressure inside the tank. The water supply means then supplies the source water (that is, the water before oxygen is oxygenated) into the first water supply pipe. The source water thus flows through the first water supply pipe and is discharged from the discharge opening into the sealed tank.

The discharged source water discharges up like a fountain towards the ceiling of the tank while radiating outward from the discharge opening, and strikes the ceiling and other inside surfaces of the sealed tank. The source water thus flows along the inside walls of the tank or bounces back and drops through the space inside the tank or flows along the outside surface of the first water supply pipe. The flow of the source water descending along the inside wall of the sealed tank or the outside surface of the first water supply pipe is then redirected by the flow control members so that the water falls from the projecting edges of the flow control members in a thin waterfall through the space inside the tank.

As the source water thus flows through the oxygen atmosphere inside the sealed tank, the oxygen that comes in contact with the water dissolves into the water, and the water finally collects in the bottom of the tank. This increases the dissolved oxygen content of the source water from 6 to 8 mg/l before being processed, to 25 to 70 mg/l, thereby generating functional water of high oxygen concentration, and that even after having been left in the air for 24 hours can maintain a dissolved oxygen content of 15 mg/l or more, more desirably 35 mg/l or more.

The functional water collected in the bottom of the sealed tank (that is, the oxygenated water) is then externally supplied from the sealed tank through the second water supply pipe by the oxygen pressure inside the tank, and the bottling unit fills transportable containers with the supplied functional water and seals the containers. Functional water sealed in containers for shipping and transportation is thus produced.

A functional water production system according to another aspect of the invention further preferably has a reverse osmosis processing unit for purifying the source water, wherein the water supply means of the oxygenation unit discharges source water purified by the reverse osmosis processing unit from the discharge opening of the first water supply pipe.

A functional water production system according to another aspect of the invention further preferably has an additive processing unit for adding at least a vitamin, mineral, amino acid, or pharmaceutical to the source water, wherein the water supply means of the oxygenation unit discharges source water processed by the additive processing unit from the discharge opening of the first water supply pipe.

A functional water production system according to another aspect of the invention further preferably has an additive processing unit for adding at least a vitamin, mineral, amino acid, or pharmaceutical to the source water purified by the reverse osmosis processing unit, wherein the water supply means of the oxygenation unit discharges source water processed by the additive processing unit from the discharge opening of the first water supply pipe.

A functional water production system according to another aspect of the invention further preferably has an additive processing unit for adding at least a vitamin, mineral, amino acid, or pharmaceutical to the source water supplied from the second water supply pipe of the oxygenation unit, wherein the bottling unit fills transportable containers with functional water processed by the additive processing unit and then seals the containers.

This functional water production method and production system first increase the contact area between the source water and oxygen gas by thus causing the source water to discharge in a radiating pattern from the discharge opening. In addition, the first and second flow control members change the flow of the source water traveling along the inside wall of the sealed tank and the outside surface of the first water supply pipe so that the water drops in a thin waterfall from the projecting edges of the flow control members through the space inside the tank, thereby causing the oxygen gas to contact both sides of the water film. Furthermore, because the oxygen pressure inside the tank is high, even more oxygen can be efficiently dissolved in the source water, and functional water that has a high dissolved oxygen concentration and inhibits a decrease in the dissolved oxygen content can be efficiently produced.

As also described above, functional water according to the present invention retains a high concentration of dissolved oxygen for up to a specific time even when left in the air, and functional water with high added value can thus be produced. In addition, the value of this functional water can be yet further enhanced by adding vitamins, minerals, amino acids, or pharmaceuticals to the water.

The functional water production method and production system of the present invention can also desirably produce this functional water.

From the following detailed description in conjunction with the accompanying drawings, the foregoing and other objects, features, aspects and advantages of the present invention will become readily apparent to those skilled in the art.

### BRIEF DESCRIPTION OF THE SEVERAL VIEWS OF THE DRAWINGS

FIG. 1 is a block diagram of a bottled water production system for manufacturing bottled drinking water as functional water according to the present invention;

FIG. 2 is a section view of the oxygenation system in a first embodiment of the invention;

FIG. 3 is a section view through line A-A in FIG. 2;

FIG. 4 is a section view through line B-B in FIG. 2;

FIG. 5 is a section view through line C-C in FIG. 2;

FIG. 6 describes the flow of water in the first embodiment of the invention;

FIG. 7 is a section view of the oxygenation system in a second embodiment of the invention;

FIG. 8 is a section view through line D-D in FIG. 7;

FIG. 9 shows the flow of water in the second embodiment of the invention;

FIG. 10 is a plan view showing the second flow control plate in a third embodiment of the invention;

FIG. 11 is a section view showing the second flow control plate in a third embodiment of the invention; and

FIG. 12 is a section view showing flow control parts in a fourth embodiment of the invention.

### DETAILED DESCRIPTION OF THE INVENTION

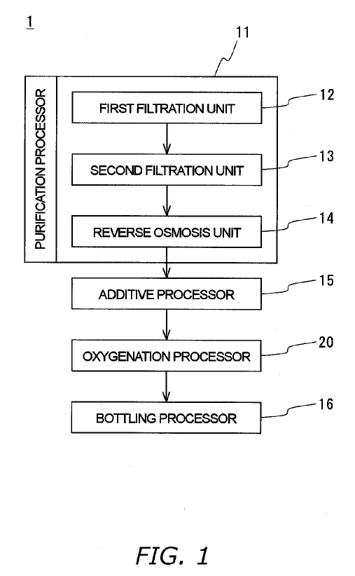

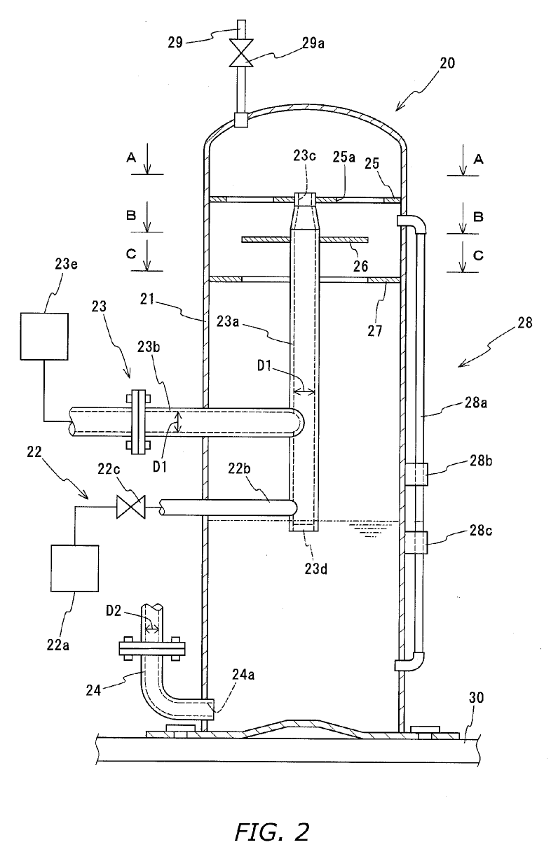

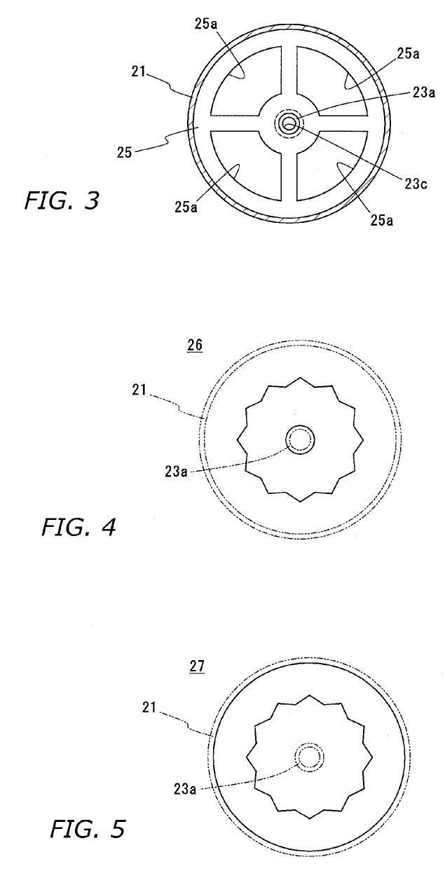

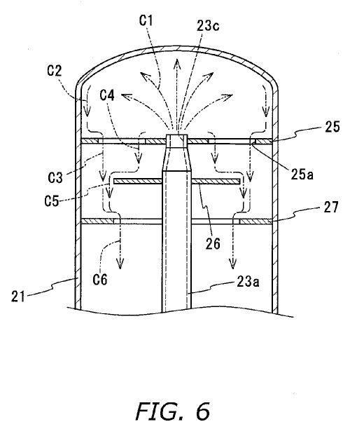

Preferred embodiments of the present invention are described below with reference to the accompanying figures. FIG. 1 is a block diagram of a bottled water production system for manufacturing bottled drinking water as functional water according to the present invention, FIG. 2 is a section view of the oxygenation system in a first embodiment of the invention, FIG. 3 is a section view through line A-A in FIG. 2, FIG. 4 is a section view through line B-B in FIG. 2, FIG. 5 is a section view through line C-C in FIG. 2, and FIG. 6 describes the flow of water in the first embodiment of the invention.

In addition to having a high concentration of dissolved oxygen, the drinking water (also referred to below as “bottled water”) produced as functional water in this first embodiment of the invention contains vitamins, minerals, and amino acids, for example, and is filled and sealed in bottles (transportable containers) having a specific internal volume. The dissolved oxygen content of this bottled water immediately after the process that dissolves the oxygen in the water (the “oxygenation process” below) is 25-70 mg/l, and is 15 mg/l or more, and further preferably 35 mg/l or more, after the water is exposed to air for 24 hours. In other words, the dissolved oxygen content when the water is sealed in the bottle is 25-70 mg/l, and the dissolved oxygen content is still at least 15 (35) mg/l or more after the bottle is left open for 24 hours.

This functional water can be desirably produced using a bottled water manufacturing system 1 such as shown in FIG. 1. As shown in FIG. 1 this bottled water manufacturing system 1 has a purification processor 11, an additive processor 15, an oxygenation processor 20, and a bottling processor 16, and manufactures bottled drinking water by sequentially processing the source water (source drinking water) through processors 11, 15, 20, and 16.

The purification processor 11 is composed of a first filtration unit 12, second filtration unit 13, and reverse osmosis unit 14.

The first filtration unit 12 removes solid particulate from the source water by means of a suitable filter, and the second filtration unit 13 uses a carbon filter to adsorb and remove trihalomethane and other chlorine compounds from the source water after processing by the first filtration unit 12. The reverse osmosis unit 14 then uses a reverse osmosis membrane to remove impurities (such as dioxin and other endocrine disruptors) that were not removed by the first and second filtration units 12 and 13 from the water processed by filtration units 12 and 13.

The additive processor 15 then adds vitamins, minerals, and amino acids to the drinking water processed and output by the reverse osmosis unit 14 of the purification processor 11.

The oxygenation processor 20 dissolves oxygen in the processed drinking water output from the additive processor 15, and thus outputs oxygenated drinking water for bottling. As shown in FIG. 2 to FIG. 5, the oxygenation processor 20 is composed of a cylindrical water tank 21 having a sealed space inside, an oxygen supply unit 22 for supplying oxygen gas into the water tank 21, a pressure gauge (not shown in the figure) for detecting the oxygen pressure inside the water tank 21, a water supply unit 23 for supplying the source water to the water tank 21, first, second, and third flow control plates 25, 26, 27 disposed towards the top inside of the tank 21, a supply pipe 24 (third water supply pipe) for supplying the oxygenated water inside the tank 21 to the outside, and a water level detection unit 28 for detecting the water level inside the tank 21.

The roof of the tank 21 is formed in a convex spherical surface, that is, the roof is dome-shaped. A ventilation pipe 29 which communicates the inside of the tank 21 with the outside is connected to the roof of the tank, and a ventilation valve 29a that is controlled to a normally closed position is disposed to the ventilation pipe 29. The bottom of the tank 21 is mounted on and supported by a suitable installation surface 30.

The oxygen supply unit 22 is composed of an oxygen supply source 22a that supplies oxygen gas, an oxygen supply pipe 22b having one end connected to the oxygen supply source 22a and the other end connected to a first water supply pipe 23a further described below, and a supply valve 22c for adjusting the flow of oxygen gas supplied from the oxygen supply source 22a through the oxygen supply pipe 22b into the tank 21. The oxygen supply unit 22 thus supplies gas through the oxygen supply pipe 22b and first water supply pipe 23a into the tank 21, thus creating an oxygen atmosphere exceeding atmospheric pressure inside the tank 21. Note that the supply valve 22c is adjusted so that the pressure detected by the aforementioned pressure gauge (not shown in the figure) or the water level detected by the water level detection unit 28 remains substantially constant.

The water supply unit 23 is composed of a first water supply pipe 23a, second water supply pipe 23b, and pump 23e. The first water supply pipe 23a is rendered so that its axis is vertically oriented and coaxial to the tank 21, and its top end is disposed at the top part of the tank 21 separated a specific distance from the ceiling of the tank 21. The second water supply pipe 23b is rendered with one end passing from the outside surface of the tank 21 to the inside of the tank 21 and connected between the top and bottom parts of the first water supply pipe 23a. The pump 23e is connected to the other end of the second water supply pipe 23b, and supplies the drinking water output from the additive processor through water supply pipes 23b and 23a into the tank 21.

The first water supply pipe 23a has an outlet 23c of which the top end is open for discharging the source water towards the ceiling of the tank 21. The inside diameter of this outlet 23c is smaller than the inside diameter (inside diameter D1) of the other portion of the first water supply pipe 23a. The other end of the oxygen supply pipe 22b is connected to the bottom part of the first water supply pipe 23a, and he this bottom end face of the first water supply pipe 23a is sealed by a suitable seal member 23d.

A backflow prevention valve not shown is also disposed to the second water supply pipe 23b. This backflow prevention valve (not shown in the figure) prevents the backflow of source water supplied into the tank 21, and prevents the oxygen gas supplied from oxygen supply pipe 22b from leaking to the outside.

One end of the third water supply pipe 24 passes from the bottom outside surface of the tank 21 to the inside of the tank 21 such that the oxygen pressure inside the tank 21 pushes the drinking water (water containing the dissolved oxygen) accumulated at the bottom inside of the tank 21 to the outside of the tank 21 through the third water supply pipe 24. The inside diameter D2 of the third water supply pipe 24 is equal to or less than the inside diameter D1 of the first and second water supply pipes 23a, 23b, and has an intake opening 24a at one end thereof for supplying the drinking water to the outside.

The first, second, and third flow control plates 25, 26, 27 are flat annular members vertically stacked with a specific distance between the plates. The first flow control plate 25 is inserted with its outside circumference surface affixed to the inside circumference surface at the top part of the tank 21 and its inside circumference fit over the top end portion of the first water supply pipe 23a. The second flow control plate 26 is fixed with its inside circumference surface fit over the top end portion of the first water supply pipe 23a below the first flow control plate 25. The third flow control plate 27 is inserted with its outside circumference surface affixed to the inside circumference surface of the top part of the tank 21 below the second flow control plate 26.

The first flow control plate 25 has four fan-shaped through-holes 25a communicating the front and back sides of the plate, controls the flow of source water flowing over the inside surface of the tank 21 and the outside surface of the first water supply pipe 23a as well as source water that strikes and falls back from the ceiling of the tank 21 (that is, controls the flow of the source water), and causes the water to fall in a thin waterfall from the through-holes 25a in the first flow control plate 25 through the space inside the tank 21.

The outside circumference (edge) of the second flow control plate 26 is serrated. The second flow control plate 26 controls the flow of source water that is flow-controlled by and falls from the first flow control plate 25 as well as source water that is reflected from the ceiling and walls and falls the through-holes 25a in the first flow control plate 25, and causes the water to fall in a thin waterfall through the space inside the tank 21 from the outside edge portion (protruding ends) of the second flow control plate 26.

The inside circumference (edge) of the third flow control plate 27 is serrated. The third flow control plate 27 controls the flow of source water that is flow-controlled by and falls from the first flow control plate 25 and second flow control plate 26 as well as water that falls through the through-holes 25a in the first flow control plate 25, and causes the water to fall in a thin waterfall through the space inside the tank 21 from the inside edge portion (protruding edges) of the third flow control plate 27.

The water level detection unit 28 is composed of a supply pipe 28a and two water level sensors 28b, 28c. The supply pipe 28a is made of an optically transparent material such as glass or plastic and is disposed to the outside of the tank 21 with the longitudinal axis of the supply pipe 28a vertically oriented. The water level sensors 28b, 28c are disposed in series one above the other on the outside surface of the tank 21 near the supply pipe 28a.

The top and bottom end portions of the supply pipe 28a communicate with the inside of the tank 21 so that the level of the fluid inside the supply pipe 28a moves up and down according to the water level inside the tank 21, and the water level sensors 28b, 28c detect this fluid level.

When the water level inside the tank 21 rises so that the fluid level inside the supply pipe 28a thus also rises and is detected by the top water level sensor 28b, this water level detection unit 28 determines that the water level inside the tank 21 exceeds an upper limit, adjusts the opening of the supply valve 22c accordingly, and increases the supply of oxygen. This increases the oxygen pressure inside the tank 21 and increases water flow out from the tank 21. The water level inside the tank 21 thus drops.

If the water level inside the tank 21 drops so that the fluid level inside the supply pipe 28a drops and is detected by the bottom water level sensor 28c, the water level detection unit 28 determines that the water level inside the tank 21 is below a lower limit, adjusts the opening of the supply valve 22c accordingly, and decreases the oxygen supply. The oxygen pressure inside the tank 21 thus decreases, the flow of water out from the tank 21 decreases, and the water level inside the tank 21 thus rises.

Oxygen gas is thus supplied from an oxygen supply source 22a through the oxygen supply pipe 22b and first water supply pipe 23a into the tank 21 of this oxygenation processor 20, creating an oxygen atmosphere with pressure exceeding atmospheric pressure inside the tank 21.

When the pump 23e then supplies the source water processed and output by the additive processor 15 (before oxygenation) to the second water supply pipe 23b, the supplied source water flows through the second water supply pipe 23b and is mixed inside first water supply pipe 23a with oxygen gas supplied from oxygen supply pipe 22b. The water thus flows in contact with the oxygen through first water supply pipe 23a, and is then discharged with the oxygen gas from outlet 23c.

The discharged source water is thus discharged upward like a fountain towards the ceiling in a pattern radiating from the center of the outlet 23c (see arrows C1 in FIG. 6). Because the inside diameter of the outlet 23c is less than the inside diameter D1 of the other part of the first water supply pipe 23a, the water pressure and thus velocity increase when the water is discharged. As a result, a broad fountain of water spouts vigorously from the outlet 23c.

The source water spouting upward from the outlet 23c strikes the ceiling and inside walls of the tank 21 and flows downward along the ceiling and walls (see arrow C2 in FIG. 6), bounces back from the contact surface (not shown in the figure), or flows down the outside surface of the first water supply pipe 23a (not shown in the figure) to the first flow control plate 25. Flow is redirected by the first flow control plate 25, and the water drops from the through-holes 25a in the first flow control plate 25 in a thin waterfall through the space inside the tank 21 (see arrows C3 and C4 in FIG. 6).

The flow of source water falling in a flow controlled by the first flow control plate 25, and source water bouncing off the inside surface of the tank 21 and dropping through the through-holes 25a in the first flow control plate 25, is then adjusted by the second flow control plate 26. As a result, the water flows from the outside edge of the second flow control plate 26 in a thin waterfall through the space inside the tank 21 (see arrow C5 in FIG. 6).

The flow of source water now falling in a flow controlled by the first flow control plate 25 and second flow control plate 26, and source water bouncing off the inside surface of the tank 21 and dropping through the through-holes 25a in the first flow control plate 25, is then adjusted by the third flow control plate 27. As a result, the water flows from the inside edge of the third flow control plate 27 in a thin waterfall through the space inside the tank 21 (see arrow C6 in FIG. 6) and collects in the bottom of the tank 21.

Oxygen is dissolved in the source water as the source water thus flows through the first water supply pipe 23a and tank 21.

As the water travels through the tank 21, the dissolved oxygen content of the source water is increased from 6-8 mg/l before processing to a high oxygen concentration of 25-70 mg/l after processing, and the dissolved oxygen content remains at least 15 mg/l or more, and preferably 35 mg/l or more, after the bottle is opened and the water is exposed to air for 24 hours. This is because when hydrogen molecules and oxygen molecules come in contact with each other in a high pressure oxygen atmosphere, some of the molecules are ionized and oxygen is dissolved in the water by ion bonds formed between hydrogen molecules and oxygen molecules. These ion bonds result in water in which the concentration of dissolved oxygen is high and the dissolved oxygen content does not decrease easily.

The oxygenated drinking water collected in the tank 21 is then supplied from the third water supply pipe 24 externally by the pressure of the oxygen gas inside the tank 21 to the above-noted bottling processor 16.

The water level detection unit 28 detects if the level of drinking water accumulated in the tank 21 goes above the upper limit or below the lower limit as described above. The top water level sensor 28b detects if the water level inside the tank 21 exceeds the upper limit from the fluid level inside the water level detection unit 28, and the bottom water level sensor 28c similarly detects if the water level drops below the lower limit as described above.

When either water level sensor 28b, 28c detects that the water level has passed the respective limit, the opening of the supply valve 22c is adjusted to adjust the oxygen supply. This adjusts the oxygen pressure inside the tank 21 and the outflow of water from the tank 21, and thereby maintains the ratio of oxygen to water inside the tank 21 within a constant range.

The first and second water supply pipes 23a, 23b and the third water supply pipe 24 are rendered so that the inside diameter D2 of the third water supply pipe 24 is equal to or less than the inside diameter D1 of the first and second water supply pipes 23a, 23b. The outflow of water from the tank 21 is thus inhibited (collection of water inside the tank 21 is facilitated) and the oxygen pressure inside the tank 21 is further increased.

Furthermore, because nitrogen and other gases contained (dissolved) in the source water are discharged from the oxygenated water in accordance with Henry's law when oxygen is dissolved in the source water, the oxygen concentration inside the tank 21 gradually decreases and the dissolved oxygen content of the source water decreases. Nitrogen and other gases inside the tank 21 must therefore be regularly discharged in order to keep the oxygen concentration inside the tank 21 at or above a specified level.

More specifically, after closing the supply valve 22c and stopping the supply of oxygen into the tank 21, the ventilation valve 29a in the ventilation pipe 29 is opened to communicate the inside of the tank 21 with the outside. The gas pressure inside the tank 21 thus drops to atmospheric pressure, and the water collected inside the tank 21 stops flowing out through the third water supply pipe 24.

Source water is then additionally supplied from the first and second water supply pipes 23a, 23b into the tank 21, thus increasing the water level inside the tank 21 and expelling air inside the tank 21 through the ventilation pipe 29 to the outside of the tank 21.

After the oxygenation processor 20 thus dissolves oxygen in the source water and produces oxygenated drinking water, the bottling processor 16 fills bottles with a specific volume of drinking water supplied from the third water supply pipe 24 of the oxygenation processor 20 and then seals the bottles.

The bottled water manufacturing system 1 of the present invention thus manufactures bottled water by first using the first filtration unit 12, second filtration unit 13, and reverse osmosis unit 14 of the purification processor 11 to successively process and purify the source water, using the additive processor 15 to add vitamins, minerals, and amino acids to the source water purified by the purification processor 11, using the oxygenation processor 20 to produce drinking water having a high concentration of dissolved oxygen from the source water to which vitamins, minerals, and amino acids were added by the additive processor 15, and finally using the bottling processor 16 to fill and seal bottles with the water produced by the oxygenation processor 20.

The dissolved oxygen concentration of the sealed bottled water produced by this bottled water manufacturing system 1 is thus high and remains high until a specific time passes after the bottle is opened and the water is exposed to air. The user can thus drink only as much of this bottled water as desired when desired, and can intake oxygen sufficient to yield the benefits described above whenever this bottled water is consumed. This bottled water is thus easier to handle and the value of the bottled water product is therefore enhanced.

The value of this oxygenated bottled water is even further enhanced because it is produced from source water containing vitamins, minerals, and amino acids added by the additive processor 15 to water that has been purified by the purification processor 11 and thus contains substantially no impurities.

In addition to being able to desirably manufacture drinking water as described above, this bottled water manufacturing system 1 also affords the following benefits.

First, more oxygen can be efficiently dissolved in the source water, and drinking water that has a high concentration of dissolved oxygen and inhibits a decrease in the dissolved oxygen content can be efficiently produced, because the contact area between the source water and oxygen gas is increased by discharging the source water upward in a radiating pattern from the outlet 23c, the flow control plates 25, 26, 27 control the flow of the source water so that the water flows from the flow control plates 25, 26, 27 through the space inside the tank 21 in a thin waterfall that exposes both sides of the descending film of water to the oxygen gas, and the oxygen pressure inside the tank 21 is high.

Furthermore, because the flow control plates 25, 26, 27 disposed inside the tank 21 do not limit the downward flow of source water through the tank 21, a large volume of source water can be efficiently processed and the water level inside the tank 21 can be quickly raised when discharging nitrogen and other released gases so that these gases can be quickly purged.

Yet further, the through-holes 25a in the first flow control plate 25 and the spaces between the flow control plates 25, 26, 27 do not become clogged by particulate and other foreign matter because the source water is purified by the purification processor 11 before being supplied to the tank 21. Removing such foreign matter from the tank 21 is therefore unnecessary, maintenance costs are thus low, and the tank 21 does not need to be produced so that the tank 21 can be disassembled for cleaning and contaminant removal. The construction of the tank 21 can thus be simplified, the manufacturing cost lowered, and the airtightness of the tank 21 can be improved.

Yet further, by providing a plurality of flow control plates 25, 26, 27 and increasing the number of times the source water flow changes, the pattern of source water flow is changed more times and the number of opportunities for contact between the source water and oxygen is increased. As a result, oxygen can be dissolved more efficiently.

Furthermore, rendering a serrated edge to the outside circumference of the second flow control plate 26 and the inside circumference of the third flow control plate 27 increases the length around the outside and inside edges of these plates, increases the surface area of the source water falling in a thin waterfall from the second flow control plate 26 and third flow control plate 27, and thus increases the area in contact with the oxygen gas. Even more oxygen can thus be efficiently dissolved in the source water.

Yet further, because the top of the tank 21 has the shape of an outwardly curving dome, the source water discharged from the outlet 23c and striking the ceiling of the tank 21 flows down along the ceiling to the first flow control plate 25. The first flow control plate 25 then adjusts the flow and drops the water through the internal space of the tank 21, increasing the dissolved oxygen content of the source water.

Yet further, the distance that the source water flows until it collects in the bottom of the tank 21 after it is discharged from the outlet 23c is increased, and the dissolved oxygen content of the source water can thus be further increased, because the top end of the first water supply pipe 23a is located in the inside top part of the tank 21 and the source water is discharged from the outlet 23c also disposed at the inside top part of the tank 21.

Furthermore, the outflow of drinking water collected inside the tank 21 can be inhibited, the oxygen pressure inside the tank 21 can be increased, and more oxygen can be efficiently dissolved in the source water flowing through the oxygen atmosphere inside the tank 21 as a result of making the inside diameter D2 of the third water supply pipe 24 equal to or less than the inside diameter D1 of the first and second water supply pipes 23a, 23b.

In addition, problems such as the water level dropping below the intake opening 24a of the third water supply pipe 24 and oxygen inside the tank 21 leaking externally through the third water supply pipe 24 can be effectively prevented because it is difficult for the water level inside the tank 21 to drop even if the oxygen pressure inside the tank 21 rises for some reason.

Furthermore, because the source water and oxygen gas are mixed in contact with each other and flow through the first water supply pipe 23a towards the outlet 23c while dissolving oxygen in the source water, a large volume of oxygen can be dissolved even more efficiently in the source water.

Yet further, because the inside diameter of the outlet 23c is smaller than the inside diameter of the other part of the first water supply pipe 23a, the pressure and speed at which the water discharges from the outlet 23c are increased, the source water discharged from the outlet 23c spreads in a wider radiating pattern, a large volume of oxygen can be dissolved even more efficiently in the source water, and the oxygen mixed with the source water inside the first water supply pipe 23a can be dissolved with even greater efficiency and volume in the source water.

Furthermore, rendering the first water supply pipe 23a coaxially to the tank 21 causes the source water discharged from the outlet 23c to be uniformly dispersed as the water flows down through the tank 21, thus enabling efficient oxygenation.

A preferred embodiment of the invention is described above but the present invention shall not be limited thereto and can be varied in many ways that will be obvious to one with ordinary skill in the related art.

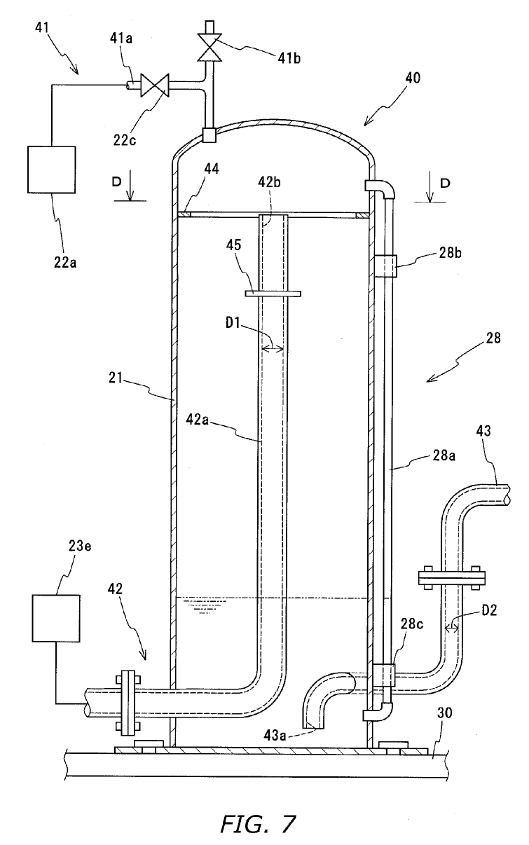

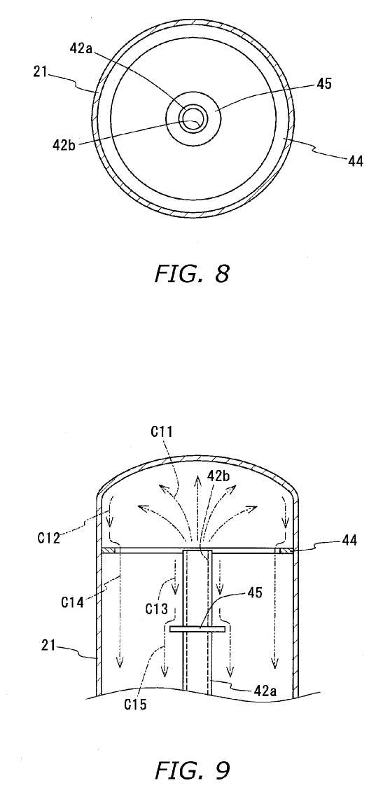

The first embodiment described above uses an oxygenation processor 20 to produce drinking water by dissolving oxygen in the source water, for example, but the invention shall not be so limited and an oxygenation processor 40 such as shown in FIG. 7 to FIG. 9 could be used instead as further described below. Note that FIG. 7 is a section view of the oxygenation system in this second embodiment of the invention, FIG. 8 is a section view through line D-D in FIG. 7, and FIG. 9 shows the flow of water in this second embodiment of the invention.

As shown in FIG. 7 this oxygenation processor 40 differs from the foregoing oxygenation processor 20 in the arrangement of the oxygen supply unit 22, water supply unit 23, third water supply pipe 24, and flow control plates 25, 26, 27 as further described below. Note that like parts in oxygenation processor 40 and oxygenation processor 20 are identified by like reference numerals and further detailed description thereof is omitted.

As shown in FIG. 7 and FIG. 8, this oxygenation processor 40 is composed of a water tank 21, an oxygen supply unit 41 for supplying oxygen gas into the tank 21, a pressure gauge (not shown in the figures), a water supply unit 42 for supplying the source water to the tank 21, a water supply pipe (second water supply pipe) 43 for externally supplying drinking water from the tank 21, first and second flow control plates 44 and 45, and a water level detection unit 28 as described above.

The oxygen supply unit 41 is composed of oxygen supply source 22a, an oxygen supply pipe 41a having one end connected to the oxygen supply source 22a and the other end connected to the top part of the tank 21, the previously described supply valve 22c, and a ventilation valve 41b for communicating the inside of the tank 21 with the outside. The oxygen supply valve 22c is controlled to a specific normally open position, and the ventilation valve 41b is normally closed.

The water supply unit 42 is composed of a first water supply pipe 42a and a pump 23e. One end of the first water supply pipe 42a passes from the outside to the inside at the bottom of the tank 21, bends substantially in an L-shape in the center of the tank 21, and then rises to the top part of the tank 21. The pump 23e is connected to the other (exterior) end of the first water supply pipe 42a.

The one (top) end of the first water supply pipe 42a is disposed separated a specific distance from the ceiling of the tank 21 and has an opening forming an outlet 42b. The opening of this outlet 42b is directed towards the ceiling inside the tank 21 and discharges the source water towards the ceiling. A backflow prevention valve not shown is also disposed to the first water supply pipe 42a, and this backflow prevention valve (not shown in the figure) prevents the backflow of source water supplied into the tank 21.

One end of the second water supply pipe 43 passes from the outside to the inside at the bottom of the tank 21 and bends substantially in an L-shape inside the tank 21 so that the end of the pipe extends toward the bottom of the tank 21. Drinking water (water infused with dissolved oxygen) collected inside the bottom of the tank 21 can thus be supplied externally to the tank 21 by the oxygen pressure inside the tank 21.

This inside (bottom) end of the second water supply pipe 43 is located a specific distance from the bottom of the tank 21 and has an intake opening 43a for externally supplying drinking water from the tank 21. The inside diameter D2 of the second water supply pipe 43 is equal to or less than the inside diameter D1 of the first water supply pipe 42a.

The first flow control plate 44 is a flat annular member of which the outside edge is inserted and affixed to the top inside circumference surface of the tank 21 at a height substantially equal to the top end of the first water supply pipe 42a. The first flow control plate 44 thus directs the flow of source water traveling along the inside circumference surface of the tank 21 and source water bouncing back off the ceiling of the tank 21 so that the water falls in a thin waterfall from the inside edge of the first flow control plate 44 down through space inside the tank 21.

The second flow control plate 45 is also a flat annular member. The inside circumference edge of the second flow control plate 45 is fit over and affixed to the outside surface at the top of the first water supply pipe 42a at a position below the first flow control plate 44. The second flow control plate 45 thus directs the flow of source water descending along the sides of the first water supply pipe 42a and source water reflected from the ceiling of the tank 21 so that the water descends in a thin waterfall from the outside edge of the second flow control plate 45 through the space inside the tank 21.

Oxygen gas is thus supplied by the oxygen supply unit 41 of this oxygenation processor 40 into the tank 21, creating an oxygen atmosphere inside the tank 21 with pressure exceeding atmospheric pressure. When source water (that is, the water before oxygenation) is then supplied by the pump 23e to the first water supply pipe 42a, the water travels through the first water supply pipe 42a and is discharged from the outlet 42b into the tank 21.

This discharged source water thus spouts upward like a fountain towards the ceiling while radiating from the center of the outlet 42b as indicated by arrows C11 in FIG. 9 and striking the ceiling and inside walls of the tank 21. The water then flows down along the ceiling and inside walls as indicated by arrows C12 in FIG. 9, is reflected off the ceiling (not shown in the figure), or flows down along the outside of the first water supply pipe 42a as indicated by arrows C13.

The source water flowing along the inside walls of the tank 21 is then redirected by the first flow control plate 44 so that the water falls in a thin waterfall from the inside edge of the first flow control plate 44 through the space inside the tank 21 (see arrows C14 in FIG. 9). In addition, water flowing down the outside of the first water supply pipe 42a is redirected by the second flow control plate 45 and falls in a thin waterfall from the outside edge of the second flow control plate 45 through the space inside the tank 21 as indicated by arrows C15 in FIG. 9.

Most of the source water that is reflected off the ceiling falls freely through the tank 21 without being directed by these flow control plates 44 and 45.

The source water thus flowing through this oxygen atmosphere then collects in the bottom of the tank 21, and the collected oxygenated source water (that is, the drinking water) is then supplied from the second water supply pipe 43 to the external bottling processor 16 by the oxygen pressure inside the tank 21.

The oxygenation processor 40 according to this embodiment of the invention thus also causes the source water to discharge upward in a radiating fountain from the outlet 42b while the first and second flow control plates 44 and 45 cause source water flowing along the inside walls of the tank 21 or the outside of the first water supply pipe 42a to drop in a thin waterfall through the oxygen atmosphere inside the tank 21, thus producing drinking water containing a high concentration of dissolved oxygen and affording the same effects as the oxygenation processor 20 of the first embodiment.

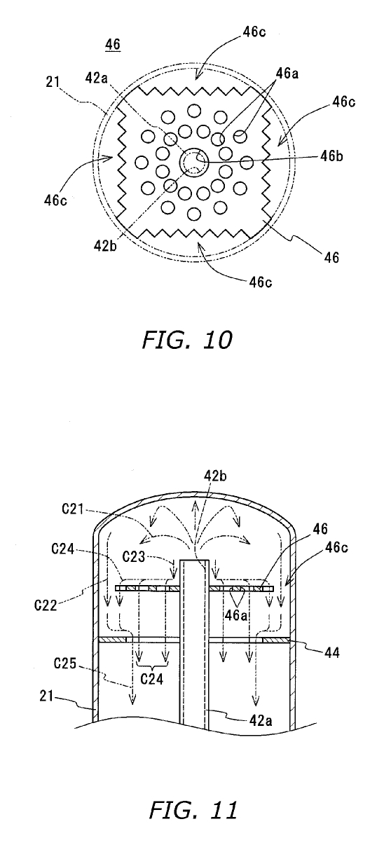

The second flow control plate 46 shown in FIG. 10 and FIG. 11 could be used instead of second flow control plate 45 in this oxygenation processor 40.

As shown in FIG. 10 and FIG. 11, the second flow control plate 46 is a flat, substantially square plate having a serrated outside edge, a plurality of through-holes 46a communicating the front and back sides of the plate, and a mounting hole 46b formed in the center. This second flow control plate 46 thus causes the source water to fall in a thin waterfall from its outside edges while also allowing the source water to fall in droplets from the through-holes 46a.

The through-holes 46a are formed in circles concentric to the mounting hole 46b, and the through-holes 46a on the inner circle and the through-holes 46a on the outer circle are offset from each other in the circumferential direction.

The second flow control plate 46 is located above the first flow control plate 44 with a specific gap therebetween, and is affixed with the inside surface of the mounting hole 46b fit over the outside surface at the top part of the first water supply pipe 42a and the four corner portions of the second flow control plate 46 supported on the inside walls of the tank 21, forming gaps 46c between the outside edge of the plate and the inside wall of the tank 21.

The source water flows through the tank 21 as described below in an oxygenation processor 40 having a first flow control plate 44 and second flow control plate 46 thus rendered.

The source water spouting upward in a radiating fountain as indicated by arrows C21 in FIG. 11 strikes the ceiling and inside walls of the tank 21 and thus flows down along the ceiling and inside walls (as indicated by arrows C22) or bounces back (not shown in the figure) and flows down around the outside surface of the first water supply pipe 42a (as indicated by arrows C23).

The source water flowing along the outside surface of the first water supply pipe 42a and the source water that bounces off the ceiling or walls is then redirected by the second flow control plate 46 and flows in a thin waterfall from the outside edges of the second flow control plate 46 or in streams of numerous water drops from the through-holes 46a in the second flow control plate 46 (as indicated by arrows C24).

The source water flowing down along the inside walls of the tank 21, source water that is reflected and passes through the gaps 46c, and source water that flows down as directed by the second flow control plate 46 is then controlled by the first flow control plate 44 and falls in a thin waterfall from the inside part of the first flow control plate 44 (as indicated by arrows C25).

By using these control plates 44 and 46, the source water discharged from the outlet 42b can thus be directed to flow in a thin waterfall from the inside and outside edges of the control plates 44 and 46 while also flowing in streams of numerous water drops from the through-holes 46a, thereby efficiently producing drinking water containing a high concentration of dissolved oxygen and achieving the other effects of present invention described above.

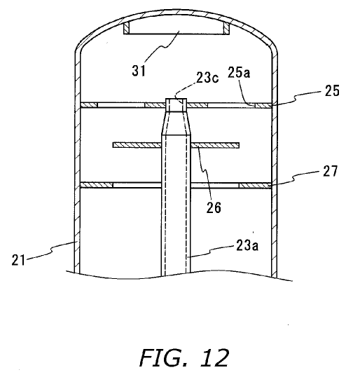

In another embodiment of the invention as shown in FIG. 12, a cylindrical flow control member 31 of which both ends are open is disposed to the ceiling of the tank 21 with the cylinder axis aligned with the vertical axis of the tank 21. The source water discharged from the outlet 23c and flowing along the ceiling is thus directed by the flow control member 31 to fall in a thin waterfall from the bottom ends of the flow control member 31 through the space inside the tank 21.

Though not shown in the figures, it will also be obvious that this flow control member 31 could be similarly rendered in oxygenation processor 40 described above.

The inside surface of this flow control member 31 could also be serrated when seen in a plan view, thus increasing the distance around the inside circumference of the flow control member 31, increasing the surface area of the source water falling from the flow control member 31, increasing the water area exposed to the oxygen gas, and thus causing even more oxygen to be efficiently dissolved in the source water.

The location of the flow control plates 25, 26, 27, 44, 45, 46 in the foregoing embodiments is not specifically limited but is preferably at the inside top of the tank 21. For example, flow control plates 25, 45, and 46 could be rendered at the top end of water supply pipe 23a, 42a or at a distance less than approximately three times the inside diameter of the outlet 23c, 42b below the top end of water supply pipe 23a, 42a, and control plates 27, 44 could be rendered at an elevation above the outlet 23c, 42b.

Such an arrangement increases the distance that the water falls until the water reaches the surface of the drinking water accumulated in the tank 21 after the water falls from the flow control plates 25, 26, 27, 44, 45, 46, thus causing even more oxygen to contact the source water and dissolve in the source water.

The vertical order of the flow control plates 25, 26, 27, 44, 45, 46 is also not limited and can be determined as desired. The flow control plates 25, 26, 27, 44, 45, 46 can also be disposed at substantially the same elevation.

The shape of the flow control plates 25, 26, 27, 44, 45, 46, particularly the shape of the inside and outside edges, and the shape and arrangement of the through-holes 25a, 46a, are also not specifically limited. For example, the inside and outside edges of the flow control plates are sawtooth-shaped in the foregoing embodiments of the invention, but the edges could have a sinusoidal or other smoothly curving wave-shaped profile, a square-wave shaped profile, or even a combination of sawtooth, smoothly curving, and square wave shapes.

The number of flow control plates 25, 26, 27, 44, 45, 46 is also not specifically limited, some or all of these flow control plates 25, 26, 27, 44, 45, 46 can be omitted, or more flow control plates than described above can be provided.

Furthermore, the top end of the water supply pipe 23a, 42a is preferably rendered at the top inside part of the tank 21 because the source water can thus be discharged at the top inside part of the tank 21, thereby increasing the distance that the source water falls before it collects in the bottom of the tank 21 after the water is discharged from the outlet 23c, 42b, and further increasing the dissolved oxygen content of the oxygenated drinking water.

Furthermore, one water supply pipe 23a, 23b, 42a is rendered in the tank 21 in the embodiments described above, but a plurality of water supply pipes 23a, 23b, 42a could be provided. In addition, the inside diameter D1 of the water supply pipe 23a, 23b, 42a is the same throughout except in the outlet 23c portion of the pipe, and the inside diameter D2 of water supply pipe 24, 43 is also the same throughout the pipe, but these diameters can be suitably changed.

The top of the tank 21 is an outwardly curving spherical surface in the foregoing embodiments, but the invention shall not be so limited and the top of the tank 21 can be an inwardly curving spherical surface (not shown in the figures). When thus formed the source water striking the ceiling of the tank 21 still flows along the ceiling to the inside walls of the tank 21, that is, to the first flow control plate 25, 44, which then directs the water flow to increase the dissolved oxygen content in the drinking water as described above.

Vitamins, minerals, and amino acids are also added to the source water by the additive processor 15 as described above, but the invention shall not be so limited and components other than vitamins, minerals, and amino acids can be added.

Yet further, the additive processor 15 adds vitamins, minerals, and amino acids to the source water after purification by the purification processor 11 in the foregoing embodiments, but the invention shall not be so limited. The oxygenation processor can be arranged, for example, so that the additive processor adds vitamins, minerals, and amino acids to the drinking water after oxygen is dissolved in source water that has been purified by the purification processor, and the bottling processor then fills and seals the drinking water in bottles after other components have been added.

The above-described arrangements of the oxygenation processor 20, 40 are also shown by way of example only, and the invention shall not be so limited. The flow of source water indicated by arrows C1 to C6, C11 to C15, and C21 to C25 is described with reference to FIG. 6, FIG. 9, and FIG. 11 by way of example only, and the actual flow of water will obviously vary according to the discharge volume and discharge pressure of the source water.

Furthermore, drinking water is used by way of example only as one type of functional water, and the invention shall not be so limited. Functional water produced by the present invention can also be used in the production of pharmaceuticals and cosmetics, for example. If used in eye medicine, eyewash, or cosmetic lotions, oxygen will be absorbed through the surface of the eye or skin with the effect of stimulating the metabolism in those areas.

Furthermore, if this functional water is used in the manufacture of pharmaceuticals or cosmetics, for example, the oxygenation processor 20, 40 can dissolve a high concentration of oxygen in source water purified by the purification processor 11, and the resulting functional water can be supplied directly to the drug or cosmetic manufacturing line or supplied sealed in suitable transportable containers.

Yet further, the additive processor 15 can add drugs to the functional water to manufacture the eye medicine, eyewash, or cosmetic lotion, for example.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. Functional water being source water into which oxygen is dissolved to a concentration more than the source water's natural dissolved oxygen concentration, wherein immediately after having been oxygenated the functional water's dissolved oxygen content is 25 to 70 mg/l, and thereafter the dissolved oxygen content of the oxygenated functional water after having been left in the air for a 24-hour time lapse is 15 mg/l or greater.

2. Functional water as set forth in claim 1, containing at least a vitamin, mineral, amino acid, or pharmaceutical.

3. Functional water as set forth in claim 1, charged into and sealed within a portable container.

4. A functional water production method comprising:
supplying pressurized oxygen gas into a hermetically sealed tank to set up in the interior of the sealed tank an oxygen-gas atmosphere of greater than atmospheric pressure;
discharging source water inside the sealed tank and causing the discharged source water to flow down in film form inside the sealed tank, to cause gas-liquid contact between the source water and the oxygen and produce functional water in which oxygen is dissolved at 25 to 70 mg/l; and
subsequently taking the produced functional water out from inside the sealed tank.

5. The functional water production method as set forth in claim 4, wherein the source water is purified by reverse osmosis, and the post-purified source water is supplied into the sealed tank.

6. The functional water production method as set forth in claim 4, wherein at least a vitamin, mineral, amino acid, or pharmaceutical is added to the source water, and thereafter the post-additive-processed source water is supplied into the sealed tank.

7. The functional water production method as set forth in claim 5, wherein at least a vitamin, mineral, amino acid, or pharmaceutical is added to the source water, and thereafter the post-additive-processed source water is supplied into the sealed tank.

8. The functional water production method as set forth in claim 4, wherein at least a vitamin, mineral, amino acid, or pharmaceutical is added to the functional water taken out of the sealed tank.

9. The functional water production method as set forth in claim 4, wherein a transportable container is filled with functional water taken out of the sealed tank, and the container is then sealed.

10. The functional water production method as set forth in claim 8, wherein a transportable container is filled with functional water to which at least a vitamin, mineral, amino acid, or pharmaceutical has been added, and the container is then sealed.

11. A functional water production system equipped with an oxygenation unit for producing functional water by dissolving oxygen into source water to a concentration more than the source water's natural dissolved oxygen concentration, and a bottling unit for filling transportable containers with the functional water produced by the oxygenation unit and then sealing the containers, wherein:
said oxygenation unit comprises
a hermetically sealed tank,
an oxygen supply means furnished with a supply line connected to the inside of the sealed tank, for supplying oxygen gas via the supply line into the sealed tank to set up in the tank interior an oxygen-gas atmosphere of greater than atmospheric pressure,
a water supply means furnished with a first water supply pipe one end of which is connected to the inside of the sealed tank, the first water supply pipe being disposed vertically inside the sealed tank and having a discharge outlet formed in the top end, said water supply means therein for discharging the source water from the discharge outlet of the first water supply pipe, directing the source water toward the ceiling of the sealed tank,
a second water supply pipe connected to the inside of the sealed tank for supplying to the exterior functional water pooling in the bottom of the sealed tank, and
a first flow-control member projecting inward from the inner surface of the sealed tank, and/or a platelike second flow-control member projecting outward from the outer peripheral surface of the first water supply pipe at the one end;
the functional water production system is therein configured for discharging the source water from the discharge outlet, directing the source water towards the ceiling of the sealed tank, and flowing source water discharged from the discharge outlet and traveling along the inside surface of the sealed tank and/or the outer peripheral surface of the first water supply pipe, down through the interior space in the sealed tank from the projecting end of the first flow control member and/or the second flow control member, to cause gas-liquid contact between the source water and oxygen gas inside the sealed tank and produce functional water; and
the bottling unit is configured for filling transportable containers with functional water supplied from the second water supply pipe of the oxygenation unit and then sealing the transportable containers.

12. The functional water production system as set forth in claim 11, further comprising a reverse osmosis processing unit for purifying the source water; wherein
the water supply means of the oxygenation unit discharges from the discharge opening of the first water supply pipe source water purified by the reverse osmosis processing unit.

13. The functional water production system as set forth in claim 11, further comprising an additive processing unit for adding at least a vitamin, mineral, amino acid, or pharmaceutical to the source water; wherein
the water supply means of the oxygenation unit discharges from the discharge opening of the first water supply pipe source water processed by the additive processing unit.

14. The functional water production system as set forth in claim 12, further comprising an additive processing unit for adding at least a vitamin, mineral, amino acid, or pharmaceutical to the source water purified by the reverse osmosis processing unit; wherein
the water supply means of the oxygenation unit discharges from the discharge opening of the first water supply pipe source water processed by the additive processing unit.

15. The functional water production system as set forth in claim 11, further comprising an additive processing unit for adding at least a vitamin, mineral, amino acid, or pharmaceutical to the source water supplied from the second water supply pipe of the oxygenation unit; wherein
the bottling unit fills transportable containers with functional water processed by the additive processing unit and then seals the containers.
